(19) United States
(12) Patent Application Publication
(10) Pub. No.: US 2020/0161687 A1
(43) Pub. Date: May 21, 2020

(54) METHOD OF REMOVING PRECIPITATE OF REDOX FLOW BATTERY AND REDOX FLOW BATTERY INCLUDING THE SAME

(71) Applicant: H2, INC., Daejeon (KR)

(72) Inventors: Shin HAN, Daejeon-Si (KR); Jee Hyang HUH, Daejeon-Si (KR); MunJa SEOK, Daejeon-Si (KR)

(21) Appl. No.: 16/356,280

(22) Filed: Mar. 18, 2019

(30) Foreign Application Priority Data
Nov. 16, 2018 (KR) 10-2018-0141195

(51) Int. Cl. H01M 8/18; H01M 8/04186

(52) U.S. Cl. CPC H01M 8/188; H01M 2300/0002; H01M 8/04186

(57) ABSTRACT

The present invention relates to a method for renmoving precipitate including: supplying anolyte stored in an anolyte tank to an anode inlet of a stuck through an anode inlet pipe; supplying the catholyte stored in a catholyte tank to a cathode inlet of the stack through an cathode inlet pipe; supplying the catholyte from the stack to the anolyte tank through an anode outlet pipe; and supplying the catholyte from the stack to the catholyte tank through an cathode outlet pipe, wherein in case of removing electrolyte precipitate in the cathode of the stack, the anolyte stored in the anolyte tank is supplied to the cathode inlet of the stack, the catholyte stored in the catholyte tank is supplied to the anode inlet of the stack, the anolyte discharged from a cathode outlet of the stack is supplied to the anolyte tank, and the catholyte discharged from an anode outlet of the stack is supplied to the catholyte tank.

### TECHNICAL FIELD

The present invention relates to a method of removing an electrolyte precipitate to prevent the performance of a stack from being degraded by an electrolyte being precipitated in a redox flow battery stack. More particularly, the present invention relates to a method of removing an electrolyte precipitate by having a structure in which electrolyte pipes are crossed.

### BACKGROUND ART

Recently, a redox flow battery has been attracting a great attention as one of the core products closely associated with renewable energy, reduction in greenhouse gas, secondary batteries, and smart grids. A fuel cell is expanding rapidly in the world market as a renewable energy source to replace fossil fuels without emission of pollutants.

Currently, most of the energy is obtained from fossil fuels, but the use of these fossil fuels has a serious adverse impact on the environment such as air pollution, acid rain, global warming, and low energy efficiency.

In recent years, in order to address the problems, interests in renewable energy and fuel cells have rapidly increased. Interests and researches on renewable energy are being developed not only domestically but also globally.

Although the renewable energy market has entered the mature stage both domestically and internationally, there is a problem that the amount of generated energy changes greatly according to environmental conditions, which is the nature of renewable energy. As a result, the energy storage system (ESS) for storing generated renewable energy is very demanded to stabilize the grid, and the redox flow battery is attracting attention as a large-scale energy storage system.

As an embodiment of the present invention, a structure of the redox flow battery includes a stack 10 in which a plurality of cells for electrochemical reactions are stacked, an anolyte tank 30a and a catholyte tank 30b for storing electrolyte, and an anolyte pump 40a and a catholyte pump 40b for supplying electrolyte from the electrolyte tank to the stack as illustrated in FIG. 1.

In the redox flow battery, charging and discharging occurs through the oxidation-reduction reaction of the electrolyte, and the operable environment is limited by the characteristics of the electrolyte.

In the case of a vanadium based redox flow battery, the operable environment range is limited by the temperature, because a pentavalent electrolyte may precipitate in a high-temperature environment and a divalent electrolyte may precipitate in a low-temperature environment.

All of the precipitates are generated in the charging state. The pentavalent electrolyte is generated by the oxidation reaction of a tetravalent electrolyte at the cathode and the divalent electrolyte is generated by the reduction reaction of a trivalent electrolyte, at the anode.

Due to the reaction heat generated in the stack during the operation of the system, a high-temperature environment occurs more easily than a low-temperature environment, in the high-temperature environment, pentavalent vanadium ions may be precipitated.

If the electrolyte precipitates, a necessary measure should be performed after stopping the system. In addition, the electrolyte precipitation may cause damage in the stack leading to the replacement of the stack requiring high replacement cost.

Accordingly, many pieces of researches are being actively conducted in the redox flow battery to expand the operation temperature range, in which the electrolyte is not precipitated. Most of them use chemical additives to prevent pentavalent vanadium ions from being precipitated.

The present invention is to flow the divalent vanadium electrolyte through the cathode of the stack which has the precipitated vanadium pentoxide by paying attention to the fact that the divalent vanadium electrolyte has a function of removing the precipitated vanadium pentoxide.

### RELATED ART DOCUMENT

### Patent Document

(Patent Document 1) Korgan Patent Registration No. 10-1130575(registered on Mar. 20, 2012)

(Patent Document 2) Kocean Patent Publicatio No. 10-2016-0035732 (Apr. 1, 2016)

### DISCLOSURE

### Technical Problem

The present invention is directed to remove the electrolyte precipitate in a stack due to abnormal operation of a redox flow battery system.

The present invention is directed to supply a divalent vanadium electrolyte in an anolyte tank to a cathode part of the stack to remove a precipitate of a pentavalent vanadium electrolyte in the cathode part of the stack without any additives.

Electrolyte precipitation may be caused by the temperature out of the operating range, and the precipitation may mainly occur in the stack due to the electrolyte temperature and the reaction heat.

When the electrolyte precipitation occurs due to an operation in an abnormal temperature range, the flow of the fluid in the stack is not smooth and the cell overvoltage may occur during charging and discharging.

Also, since membranes may be damaged by the precipitate,a rapid measure is necessary to protect the stack.

### Technical Solution

An aspect of the present invention provides a method of removing precipitate including: supplying an anolyte stored in an anolyte tank 30a to an anode inlet of a stack 10 through an anode inlet pipe 50a; supplying a catholyte stored in a catholyte tank 30b to a cathode inlet of the stack 10 through an cathode inlet pipe 60a; supplying the anolyte from the stack 10 to the anolyte tank 30a through an anode outlet pipe 50b; and supplying the catholyte from the stack 10 to the catholyte tank 30b through an cathode outlet pipe 60b, wherein in case of removing an electrolyte precipitate in the cathode of the stack 10,the anolyte stored in the anolyte tank 30a is supplied to the cathode inlet of the stack 10, the catholyte stored in the catholyte tank 30b is supplied to the anode inlet of the stack 10, the anolyte discharged from a cathode outlet of the stack 10 is supplied to the anolyte tank 30a, and the catholyte discharged from an anode outlet of the stack 10 is supplied to the catholyte tank 30b.

Another aspect of the present invention provides a redox flow battery including: an anolyte tank 30a storing an anolyte; a catholyte tank 30b storing a catholyte; an anode inlet pipe for supplying the anolyte to a stack 10; an cathode inlet pipe 60a for supplying the catholyte to the stack 10; an anode outlet pipe for supplying the anolyte from the stack 10 to the anolyte tank 30a; an cathode outlet pipe 60b for supplying the catholyte from the stack 10 to the catholyte tank 30b; an anode inlet bypass pipe connected with the anode inlet pipe 50a to supply the anolyte to a cathode inlet of the stack 10; and an cathode outlet bypass pipe connected with the anode outlet pipe to supply the anolyte discharged from a cathode outlet of the stack to the anolyte tank 30a.

The redox flow battery may further include a cathode inlet bypass pipe 61a connected with the cathode inlet pipe 60a to supply the catholyte to an anode inlet of the stack; and an anode outlet bypass pipe 51b connected with the cathode outlet pipe 60b to supply the catholyte discharged from an anode outlet of the stack to the catholyte tank.

The anode inlet pipe 50a may be connected with the cathode inlet pipe 60a by the anode inlet bypass pipe 51a, the cathode inlet pipe 60a may be connected with the anode inlet pipe 50a by the cathode inlet bypass pipe 61a, the cathode outlet pipe 60b may be connected with the anode outlet pipe 50b by the cathode outlet bypass pipe 61b, and the anode outlet pipe 50b may be connected with the cathode outlet pipe 60b by the anode outlet bypass pipe 51b.

An anode inlet valve 50aa in the anode inlet pipe 50a, a cathode inlet valve 60aa in the cathode inlet pipe 60a, an anode outlet valve 50bb in the anode outlet pipe 50b, an cathode outlet valve 60bb in the cathode outlet pipe 60b, an anode inlet bypass valve 51aa in the anode inlet bypass pipe 51a, a cathode inlet bypass valve 61aa in the cathode inlet bypass pipe 61a, an anode outlet bypass valve 51bb in the anode outlet bypass pipe 51b, and an cathode outlet bypass valve 61bb in the cathode outlet bypass pipe 61b may be installed.

In a normal state, the anode inlet valve 50aa, the cathode inlet valve 60aa, the anode outlet valve 50bb, and the cathode outlet valve 60bb may be in an open state and the anode inlet bypass valve 51aa, the cathode inlet bypass valve 61aa, the anode outlet bypass valve 51bb, and the cathode outlet bypass valve 61bb may be in a closed state, and in case of removing the electrolyte precipitate in the cathode of the stack, the anode inlet valve 50aa, the cathode inlet valve 60aa, the outlet anode valve 50bb, and the cathode outlet valve 60bb may be in a closed state and the anode inlet bypass valve 51aa, the cathode inlet bypass valve 61aa, the anode outlet bypass valve 51bb, and the cathode outlet bypass valve 61bb may be in an open state.

### Advantageous Effects

According to the present invention, when the electrolyte is precipitated in the stack due to a high temperature caused by an abnormal operation after the system is installed, the electrolyte precipitate may be removed by a simple adjustment of the pipes and the problems as to the maintenance of the stack may be rapidly and conveniently solved.

That is, the electrolytic precipitation problem in the stack may be solved by a simple operation of valves installed in the pipe, and a separate additive is not necessary to remove the electrolyte precipitate.

Further, even if the electrolyte precipitation occurs in the stack, there is no need to replace the stack and this prevents a high replacement cost in advance.

### DESCRIPTION OF DRAWINGS

FIG. 1 is a configuration diagram of a redox flow battery which is applied to the present invention.

FIGS. 2 and 3 are configuration diagrams of a redox flow battery improved by the present invention.

### MODES OF THE INVENTION

Hereinafter, the present invention will be described in more detail with reference to the accompanying drawings.

The accompanying drawings illustrate exemplary embodiments of the present invention and are provided to explain the present invention in detail. However, the technical scope of the present invention is not limited thereto.

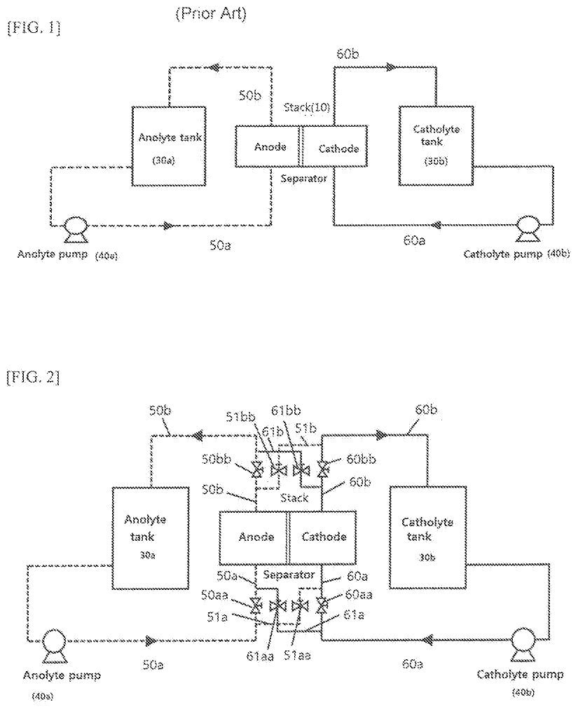

As illustrated in FIG. 1, a redox flow battery includes catholyte and anolyte tanks, a plurality of stacks, pipes, catholyte and anolyte pumps, a battery management system (BMS), and sensors.

In the redox flow battery, an anode inlet pipe 50a and a cathode inlet pipe 60a for supplying the electrolyte in the electrolyte tank to the stack and an anode outlet pipe 50b and a cathode outlet pipe 60b for supplying the electrolyte of the stack to the electrolyte tanks 30a and 30b, are installed.

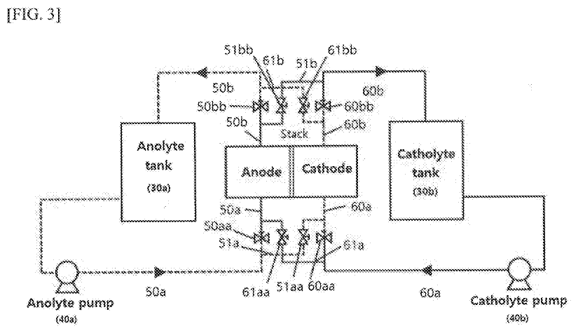

FIGS. 2 and 3 are configuration diagrams of the present invention, and the redo flow battery further includes an anode inlet bypass pipe 51a which is able to supply the anolyte of the anode inlet pipe 50a to the cathode inlet pipe 60a, and a cathode inlet bypass pipe 61a which is able to supply the catholyte of the cathode inlet pipe 60a to the anode inlet pipe 50a.

Similarly, the redox flow battery further includes an anode outlet bypass pipe 51b which is able to supply the catholyte of the anode outlet pipe 50b to the cathode outlet pipe 60b and a cathode outlet bypass pipe 61b which is able to supply the anolyte of the cathode outlet pipe 60b to the anode outlet pipe 50b.

In each pipe, an anode inlet valve 50aa, an anode inlet bypass valve 51aa, a cathode inlet valve 60aa, a cathode inlet bypass valve 61aa, an outlet anode valve 50bb, an anode outlet bypass valve 51bb, a cathode outlet valve 60bb, and a cathode outlet bypass valve 61bb are installed.

As FIG. 2 illustrates a normal state, the anolyte is supplied to the stack through the anode inlet pipe 50a and the anolyte discharged from the stack is supplied to the electrolyte tank 30a through the anode outlet pipe 50b.

Likewise, the catholyte is supplied to the stack through cathode inlet pipe 60a, and the catholyte discharged from the stack is supplied to the electrolyte tank 30b through the cathode outlet pipe 60b.

In this case, the anode inlet valve 50aa, the cathode inlet valve 60aa, the outlet anode valve 50bb, and the cathode outlet valve 60bb are in an open state, and the anode inlet bypass valve 51aa, the cathode inlet bypass valve 61aa, the anode outlet bypass valve 51bb and the cathode outlet bypass valve 61bb are in a closed state.

FIG. 3 is a diagram for supplying a divalent vanadium electrolyte of the anode to the cathode when a pentavalent vanadium electrolyte is precipitated in the cathode of the redox flow battery.

The anode inlet valve 50aa, the cathode inlet valve 60aa, the outlet anode valve 50bb, and the cathode outlet valve 60bb are in a closed state, and the anode inlet bypass valve 51aa, the cathode inlet bypass valve 61aa, the anode outlet bypass valve 51bb, and the cathode outlet bypass valve 61bb are in an open state.

The divalent vanadium electrolyte of the anolyte tank is supplied to the cathode inlet of the stack through the anode inlet pipe 50a, the anode inlet bypass pipe 51a and the cathode inlet pipe 60a to dissolve the electrolyte precipitated in the cathode.

Alternatively, the divalent vanadium electrolyte of the anolyte tank may be supplied directly to the cathode inlet of the stack through the anode inlet pipe 50a and the anode inlet bypass pipe 51a.

The divalent vanadium electrolyte which has dissolved the electrolyte precipitate in the cathode of the stack is supplied to the anolyte tank 30a through the cathode outlet pipe 60b, the cathode outlet bypass pipe 61b, and the anode outlet pipe 50b.

Alternatively, the divalent vanadium electrolyte may be supplied directly from the outlet of the stack to the cathode outlet bypass pipe without passing through the cathode outlet pipe 60b.

In this case, the catholyte existing in the catholyte tank is supplied to the anode inlet of the stack through the cathode inlet pipe 60a, the cathode inlet bypass pipe 61a, and the anode inlet pipe 50a by the operation of the cathode pump 40b.

The catholyte is discharged through the anode outlet of the stack and is supplied to the catholyte tank 30b through the anode outlet pipe 50b, the anode outlet bypass pipe 51b and the cathode outlet pipe 60b.

The catholyte may be directly supplied from the cathode inlet bypass pipe 61a to the anode inlet of the stack or may be directly supplied from the anode outlet of the stack to the anode outlet bypass pipe 51b.

The divalent anolyte dissolves the electrolyte precipitate in the cathode.

The reason why the pentavalent catholyte is circulated together is to minimize a pressure difference in the stack.

Since mechanical defects may occur in the stack due to the pressure difference when the electrolyte is circulated in only one side, it is preferable to circulate the electrolyte in the cathode and the anode.

As described above, the present invention is to exchange electrolytes of the anode and the cathode with each other when the electrolytes are supplied to the stack and exchange the exchanged electrolytes again when the electrolyte is discharged from the stack, so that the electrolytes are exchanged in only the stack among the overall system.

When a plurality of stacks are provided, bypass valves may be installed in the pipe before being branched to the stacks and the pipe connecting the stacks to the tank.

In the present invention, electrolyte precipitates are removed from the cathode part of the stack by using the fact that the precipitate of the pentavalent vanadium electrolyte in the cathode is dissolved when mixed with the divalent vanadium electrolyte.

After cross-supplying the electrolyte, the crossed electrolyte is replaced again to be supplied to the original tank in order to maintain the full charging state of the electrolyte tank.

The cross valve (=the bypass valve) may be easily made as a complicated shape by using an elastic pipe, a hose, and the like.

For example, V₂O₅ may be precipitated in the cathode of a vanadium redox flow battery when the charging state and the temperature are high, and in order to remove the precipitate of V₂O₅ in the cathode, the anolyte (V²⁺) in the charged state flows into the V₂O₅ .

This uses the fact that V²⁺has a function of removing V₂O₅ precipitate.

The above description just illustrates the technical spirit of the present invention and various changes and modifications can be made by those skilled in the art to which the present invention pertains without departing from art essential characteristic of the present invention. Accordingly, the various embodiments disclosed herein are not intended to limit the technical spirit but describe with the true scope and spirit being indicated by the following claims. The protective scope of the present invention should be construed based on the following claims, and all the techniques in the equivalent scope thereof should be construed as falling within the scope of the present invention.

### EXPLANATION OF REFERENCE NUMERALS AND SYMBOLS

| | |
|---|---|
| 30a: Anolyte tank | 30b: Catholyte tank |
| 40a: Anolyte pump | 40b: Catholyte pump |
| 50a: Anode inlet pipe | 50b: Anode outlet pipe |
| 60a: Cathode inlet pipe | 60b: Cathode outlet pipe |

1. A method for removing the precipitate of a redox flow battery comprising:
supplying the anolyte stored in an anolyte tank to an anolyte inlet of a stack through an anode inlet pipe;
supplying the catholyte stored in a catholyte tank to a catholyte inlet of the stack through a cathode inlet pipe;
supplying the anolyte from the stack to the anolyte tank through an anode outlet pipe; and
supplying the catholyte from the stack to the catholyte tank through a cathode outlet pipe;
wherein in case of removing the precipitate in the cathode of the stack, the anolyte stored in the anolyte tank is supplied to the catholyte inlet of the stack, the catholyte stored in the catholyte tank is supplied to the anolyte inlet of the stack, the anolyte discharged from the catholyte outlet of the stack is supplied to the anolyte tank, and the catholyte discharged from the anolyte outlet of the stack is supplied to th catholyte tank.

2. A redox flow battery comprising;
an anolyte tank storing an anolyte;
a catholyte tank storing a catholyte;
an anode inlet pipe for supplying the anolyte to a stack;
a cathode inlet pipe for supplying the catholyte to the stack;
an anode outlet pipe for supplying the anolyte from the stack to the anolyte tank;
a cathode outlet pipe for supplying the catholyte from the stack to the catholyte tank;
an anode inlet bypass pipe connected with the anode inlet pipe to supply the anolyte to a cathode inlet of the stack;
a cathode outlet bypass pipe connected with the anode outlet pipe to supply the anolyte discharged from a cathode outlet of the stack to the anolyte tank;
a cathode inlet bypass pipe connected with the cathode inlet pipe to supply the catholyte to an anode inlet of the stack; and
an anode outlet bypass pipe connected with the cathode outlet pipe to supply the catholyte discharged from an anode outlet of the stack to the catholyte tank.

3. (canceled)

4. The redox flow battery of claim 2, wherein the anode inlet pipe is connected with the cathode inlet pipe by the anode inlet bypass pipe, the cathode inlet pipe is connected with the anode inlet pipe by the cathode inlet bypass pipe, the cathode outlet pipe is connected with the anode outlet pipe by the cathode outlet bypass pipe, and the anode outlet pipe is connected with the cathode outlet pipe by the anode outlet bypass pipe.

5. The redox flow batter of claim 4, wherein an anode inlet valve in the anode inlet pipe, a cathode inlet valve in the cathode inlet pipe, an anode outlet valve in the anode outlet pipe, an cathode outlet valve in the cathode outlet pipe, an anode inlet bypass valve in the anode inlet bypass pipe, a cathode inlet bypass valve in the cathode inlet bypass pipe, an anode outlet bypass valve in the anode outlet bypass pipe, and the cathode outlet bypass valve in the cathode outlet bypass pipe are installed,
in a normal state, the anode inlet valve, the cathode inlet valve, the anode outlet valve, and the cathode outlet valve are in the open state, and the anode inlet bypass valve, the cathode inlet bypass valve, the anode outlet bypass valve, and the cathode outlet bypass valve are in the closed state, and
in case of removing the electrolyte precipitate in the cathode of the stack, the anode inlet valve, the cathode inlet valve, the outlet anode valve, and the cathode outlet valve are in the closed state, and the anode inlet bypass valve, the cathode inlet bypass valve, the anode outlet bypass valve, and the cathode outlet bypass valve are in the open state.
